(19) United States
(12) Patent Application Publication
(10) Pub. No.: US 2015/0330863 A1
(43) Pub. Date: Nov. 19, 2015

(54) Method and System for Identifying Leaks in Fluid Pipe Construction

(71) Applicant: Triple Plus, Yokneam (IL)

(72) Inventors: Omri Dotan, Zichron Yaacov (IL); Shaul Margalit, Givatayim (IL); Dov Barkay, Ramat Ishay (IL)

(21) Appl. No.: 14/807,295

(22) Filed: Jul. 23, 2015

Related U.S. Application Data
(63) Continuation-in-part of application No. 13/108,288, filed on May 16, 2011.

(51) Int. Cl. G01M 3/24

(52) U.S. Cl. CPC G01M 3/243

(57) ABSTRACT

System and method for identifying defects in a fluid pipe construction, where the method includes: receiving output signal data of at least two acoustic sensors configured for measuring flow related acoustic measures of the pipe constructions at least at the entrance point and at least one exit points thereof; and processing the received output signal data for identifying one or more types of flow related defects, using ultrasonic spectral range of the received signal data, wherein the identification is carried out by calculating at least the difference between the flow in the entrance and exit points of the pipe construction within the ultrasonic spectral range and comparing the calculated difference with at least two references indicating at least two flow states. The references are indicative of the flow states within the ultrasonic spectral range under normal conditions.

### CROSS-REFERENCE TO RELATED PATENT APPLICATIONS

This application is a continuation in part (CIP) of U.S. patent application Ser. No. 13/108,288 (publication no. US 2012/02965802 A1) filed on May 16, 2011, which is incorporated herein by reference in its entirety.

### FIELD OF THE INVENTION

The present invention relates to the field of identification of flow of fluid in pipes construction and more specifically to identification of leaks in pipe construction using acoustical sensors.

### BACKGROUND OF THE INVENTION

There are various known in the art systems for leak detection:

US application No. 2006174707 discloses a device for detecting and controlling abnormal flow occurrences in a liquid or gas-carrying infrastructure using acoustics sensors.

U.S. Pat. No. 5,040,409 discloses an acoustic sensor used to determine when a leak occurs in a sprinkling system. When a catastrophic leak is detected, an alarm signal is generated and a shutoff valve may be actuated in order to prevent loss of fluid and possible damage that can occur due to localized high flow of the fluid that is being sprayed.

US application No. 2004128034 discloses liquid flow detection using a microphone or other acoustic sensor to detect the acoustic signature of liquid flow through a pipe. Based on the analysis of the acoustic signature of the liquid flow, a determination is made whether a fault or leak in the line has occurred.

Application No. WO0151904 discloses a method for detection of leaks in plastic water distribution pipes by processing the sound or vibration induced in the pipe by water escaping under pressure. The leak is located using the difference in arrival times of two leak signals as determined from the cross-correlation function traditionally used in leak detection applications or an enhanced impulse response function.

EP application No. 1077371 discloses a method for detection of leaks using leak-specific sound signals, and/or the detection of the level in the fitting with an arrangement mounted in at least one fitting and/or pipeline, and outputting a leak alarm signal if a leak is detected and/or a level warning signal if the level exceeds or falls below a certain value.

The various leak detection methods described above use acoustic sensors located within the pipes, requiring complicated algorithm for identifying leak along the pipe, such solution may not be used to detect real time fluid leak within pipe construction for immediate activation of shutoff valve.

### SUMMARY OF THE INVENTION

The present invention provides a method for identifying defects in a fluid pipe construction comprising for each timeframe: (a) receiving output signal data of at least two acoustic sensors configured for measuring flow related acoustic measures of said pipe constructions at least at the entrance point and at least one exit points thereof; and (b) processing the received output signal data for identifying one or more types of flow related defects, using ultrasonic spectral range of the received signal data, wherein the identification is carried out by calculating at least the difference between the flow in the entrance and exit points of the pipe construction within the ultrasonic spectral range and comparing the calculated difference with at least two references indicating at least two flow states, wherein the references are indicative of the flow states within the ultrasonic spectral range under normal conditions.

According to some embodiments, the processing of the received signal data further comprises transforming the signal or at least ultrasonic range part thereof to the time domain. This processing optionally further comprises selecting at least one frequency within the ultrasonic range as the representative indication of the flow and comparing value of its amplitude or a parameter related thereto with states references values associated with the same corresponding at least one frequency.

According to some embodiments, the method further comprises outputting an alert message upon identification of a flow defect.

The alert message is optionally outputted by sending thereof to at least one end device of at least one authorized user over at least one communication link.

According to some embodiments, the signal data is received from the acoustic sensors through wireless communication.

According to some embodiments, the at least two references comprise three references indicating three different flow states of: closed, in which no faucet of the pipe construction is open and therefore not exiting flow is sensed, fully open, in which at least one of the pipe construction faucets is fully open enabling full flow of the fluid through the piping thereof, and semi-closed, in which some of the faucets are open or one is semi-open.

According to some embodiments, the determination of a flow defect comprises determination of leakage defect in the pipeline of the pipe construction, and wherein the leakage is identified once the calculated difference between the input and output flows exceeds a predefined threshold.

According to some embodiments, the method further comprises operating a preliminary learning process for determining the at least two references of the specific pipe construction.

The present invention also provides a system for identifying defects in a fluid pipe construction, comprising: a plurality of acoustic sensors located in proximity to a pipeline of the pipe construction foe measuring flow in different locations of the pipeline including at least at the entrance point and at least one exit point thereof; and at least one processing unit configured for receiving output signal data of the acoustic sensors and processing the received output signal data for identifying one or more types of flow related defects, using ultrasonic spectral range of the received signal data, wherein the identification is carried out by calculating at least the difference between the flow in the entrance and exit points of the pipe construction within the ultrasonic spectral range and comparing the calculated flow difference with at least two references indicating at least two flow states, said references are indicative of the flow states within the ultrasonic spectral range under normal conditions.

According to some embodiments, the system further comprises at least one detection unit positioned in proximity to at least one exit point of said pipe construction and comprises an acoustic sensor and a wireless communication unit; and at least one electronically controlled shutoff unit installed in proximity to each entrance point of the pipe construction, the at least one shutoff unit comprising a controllable valve, an acoustic sensor and a wireless communication unit arranged for wirelessly communicating with the at least one detection unit via at least one first communication link, a controller network device for receiving identifying flow related defects and control the valve of each shutoff unit according to the detected defect and a predefined control program associated with the identified defect, wherein the processing unit is embedded in the shutoff unit.

The wireless communication unit is optionally configured to receive and transmit data through at least one of the following wireless communication technologies: radio frequency (RF) based communication, optical communication.

The system according to some embodiments further comprises at least one non-acoustic sensor for flow measurement, wherein said processing is done also using output data of the at least one non-acoustic sensor.

According to some embodiments, the at least one shutoff unit is further configured to output and/or transmit alerts upon identification of a flow defect.

The processing optionally further comprises selecting at least one frequency within the ultrasonic range as the representative indication of the flow and comparing value of its amplitude or a parameter related thereto with states references values associated with the same corresponding at least one frequency.

### BRIEF DESCRIPTION OF THE DRAWINGS

The patent or application file contains at least one drawing executed in color. Copies of this patent or patent application publication with color drawings will be provided by the Office upon request and payment of the necessary fee.

The present invention will be more readily understood from the detailed description of embodiments thereof made in conjunction with the accompanying drawings of which:

FIG. 1 is a block diagram illustrating the components of the leak detection system according to some embodiments of the invention.

FIG. 2 is a block diagram illustrating the controller device according to some embodiments of the invention.

FIG. 3 is a block diagram of the detection unit according to some embodiments of the invention.

FIG. 4 is an illustration the flow leak detection process according to some embodiments of the invention.

FIG. 5 is an illustration the flow leak detection process according to some embodiments of the invention.

FIG. 6 is a block diagram the shutoff unit according to some embodiments of the invention;

FIG. 7 is an illustration tap and associated detection unit according to some embodiments of the invention.

FIG. 8 is an illustration shutoff unit according to some embodiments of the invention.

FIG. 9 is a flowchart schematically illustrating a process of identifying defects in a fluid pipe construction, according to some embodiments of the invention.

FIG. 10 shows a table showing all scenarios tested in the feasibility study.

FIGS. 11A-11D show estimated spectrums of flow vs. no-flow when the microphones is coupled over the tap: FIG. 11A shows a spectrum for high-flow with air conditioning off; FIG. 11B shows a spectrum for low flow with air conditioning off; FIG. 11C shows a spectrum for high flow with air conditioning on; and FIG. 11D shows a spectrum for low flow with air conditioning on.

FIGS. 12A-12D show estimated spectrums of flow vs. no-flow when the microphone is located 0.3 meters from the tap: FIG. 12A shows a spectrum for High flow with air conditioning off; FIG. 12B shows a spectrum for low flow with air conditioning off; FIG. 12C shows a spectrum for high flow with air conditioning on; and FIG. 12D shows a spectrum for low flow with air conditioning on.

FIGS. 13A-13D show estimated spectrums of flow vs. no-flow when the microphone is located 1.5 meters from the tap: FIG. 13A shows a spectrum for high flow with air conditioning off; FIG. 13B shows a spectrum for low flow with air conditioning off; FIG. 13C shows a spectrum for high flow with air conditioning on; and FIG. 13D shows a spectrum for low flow with air conditioning on.

FIG. 14 shows the three highest features variance coordinates of the scenarios shown in FIG. 10 in terms of band-pass frequencies.

FIGS. 15A-15D show a 3D scatter plot of selected features of flow vs. no-flow when the microphone is coupled over the tap: FIG. 15A shows a scattered plot of high flow with air conditioning off; FIG. 15B shows a scattered plot of low flow with air conditioning off; FIG. 15C shows a scattered plot of high flow with air conditioning on; and FIG. 15D shows a scattered plot of low flow with air conditioning on.

FIGS. 16A-16D show a 3D scatter plot of selected features of flow vs. no-flow when the microphone is located 0.3 meters from the tap: FIG. 16A shows a scattered plot of high flow with air conditioning off; FIG. 16B shows a scattered plot of low flow with air conditioning off; FIG. 16C shows a scattered plot of high flow with air conditioning on; and FIG. 16D shows a scattered plot of low flow with air conditioning on.

FIGS. 17A-17D show a 3D scatter plot of selected features of flow vs. no-flow when the microphone is located 1.5 meters from the tap: FIG. 17A shows a scattered plot of high flow with air conditioning off; FIG. 17B shows a scattered plot of low flow with air conditioning off; FIG. 17C shows a scattered plot of high flow with air conditioning on; and FIG. 17D shows a scattered plot of low flow with air conditioning on.

FIGS. 18A-18D show Gaussian qui-probability plots for a system in which the microphone is coupled over the tap, wherein FIG. 18A shows a plot for high flow with air conditioning off; FIG. 18B shows a plot for low flow with air conditioning off; FIG. 18C shows a plot for high flow with air conditioning on; and FIG. 18D shows a plot for low flow with air conditioning on.

FIGS. 19A-19D show Gaussian qui-probability plots for a system in which the microphone is located 0.3 meters from the tap, wherein FIG. 19A shows a plot for High flow with air conditioning off; FIG. 19B shows a plot for low flow with air conditioning off; FIG. 19C shows a plot for high flow with air conditioning on; and FIG. 19D shows a plot for low flow with air conditioning on.

FIGS. 20A-20D show Gaussian qui-probability plots for a system in which the microphone is located 1.5 meters from the tap, wherein FIG. 20A shows a plot for high flow with air conditioning off; FIG. 20B shows a plot for low flow with air conditioning off; FIG. 20C shows a plot for high flow with air conditioning o; and FIG. 20D shows a plot for low flow with air conditioning on.

FIG. 21 shows a table indicating all scenarios tested in the feasibility study.

FIG. 22 shows a table indicating all the different scenarios tested wherein the tap is in different high or low condition and the air condition is on or off.

FIGS. 23A-23D show flow vs. no-flow spectrums of acoustic signals recorded by using a microphone located over a kitchen tap: FIG. 23A shows the spectrum in high flow with air conditioning off scenario; FIG. 23B shows the spectrum in low flow with air conditioning off scenario; FIG. 23C shows the spectrum in high flow with air conditioning on scenario; and FIG. 23D shows the spectrum in low flow with air conditioning on scenario.

FIGS. 24A-24D show flow vs. no-flow spectrums of acoustic signals recorded by using a microphone located 0.5 meters from the kitchen tap: FIG. 24A shows the spectrum in high flow with air conditioning off scenario; FIG. 24B shows the spectrum in low flow with air conditioning off scenario; FIG. 23C shows the spectrum in high flow with air conditioning on scenario; and FIG. 23D shows the spectrum in low flow with air conditioning on scenario.

FIGS. 25A-25D show flow vs. no-flow spectrums of acoustic signals recorded by using a microphone located over a shower tap: FIG. 25A shows the spectrum in high flow with air conditioning off scenario; FIG. 25B shows the spectrum in low flow with air conditioning off scenario; FIG. 25C shows the spectrum in high flow with air conditioning on scenario; and FIG. 25D shows the spectrum in low flow with air conditioning on scenario.

FIGS. 26A-26D show flow vs. no-flow spectrums of acoustic signals recorded by using a microphone located 0.5 meters from the shower tap: FIG. 26A shows the spectrum in high flow with air conditioning off scenario; FIG. 26B shows the spectrum in low flow with air conditioning off scenario; FIG. 26C shows the spectrum in high flow with air conditioning on scenario; and FIG. 26D shows the spectrum in low flow with air conditioning on scenario.

FIG. 27 shows a table indicating noise conditions used for the sound acquisition.

FIGS. 28A-28D show scatter plots of cross-database feature extraction for various scenarios in which the microphone is either over the kitchen or shower tap at different distances therefrom: FIG. 28A shows the plot in a scenario in which the microphone is over the kitchen tap; FIG. 28B shows the plot in a scenario in which the microphone is located 0.5 meters from the kitchen tap; FIG. 28C shows the plot in a scenario in which the microphone is over the shower tap; and FIG. 28D shows the plot in a scenario in which the microphone is located 0.5 meters from the shower tap.

FIG. 29 shows a reduction to 2D of the scattered plot of FIG. 28D.

### DETAILED DESCRIPTION OF SOME EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The term pipe construction used herein refers to any piping system that delivers fluids such as liquid or gas of any kind such as water oil gas and the like. The pipe construction may have a single entrance point and a single exit point or a single entrance point and multiple exit points since it may ramify or it may include multiple entrance points and multiple exit points. Each of the exit points may connect to a tap having a valve allowing opening and closing thereof.

A leak refers to leak in the pipeline of the pipe construction that occurs anywhere in between the entrance point(s) and the exit point(s).

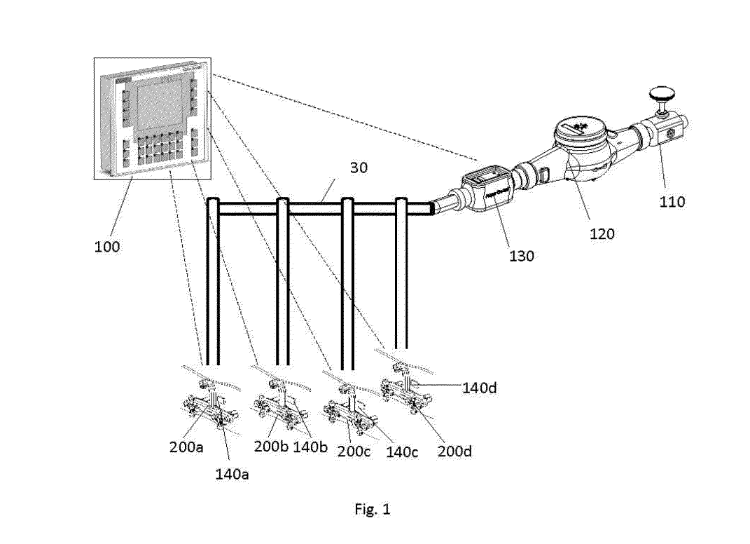

FIG. 1 illustrates the main components of the leak detection system implemented in pipe construction 30 system according to the present invention. The system includes, a controller unit 100 including a processor and a transceiver configured for receiving and transmitting data, processing data and controlling other components of the system by transmission of signals thereto, entrances point valve 110, metering unit 112, shutoff unit 130 positioned at the entrance point such that it can close its entrance point valve 110 and plurality of detection devices 140a-140d positioned in proximity of controlled exit points taps 200a-200d of the pipe construction 30. The controller unit 100 communicates through a wireless communication link with the detection devices 140a-140d and with the shutoff unit 130 and is programmed to manage valves at the entrance point and the exit points on the basis of the received measurements from the acoustics sensors at the entrance point and exits points. The detection units 112 are position at different point, each unit in proximity to at least one controlled exit point such as a tap. For example, the controller unit 100 is configured to calculate an estimated water amount flowing through the entrance point and compare this amount with the sum of the water amount at all the exit points combined such that if the amounts do not match to a certain predefined degree (over a difference threshold) a leak is identified. Once a leak is identified, the controller unit 100 sends a shutoff signal to the shutoff unit 130 at the entrance point which will in turn close the entrance point valve 110.

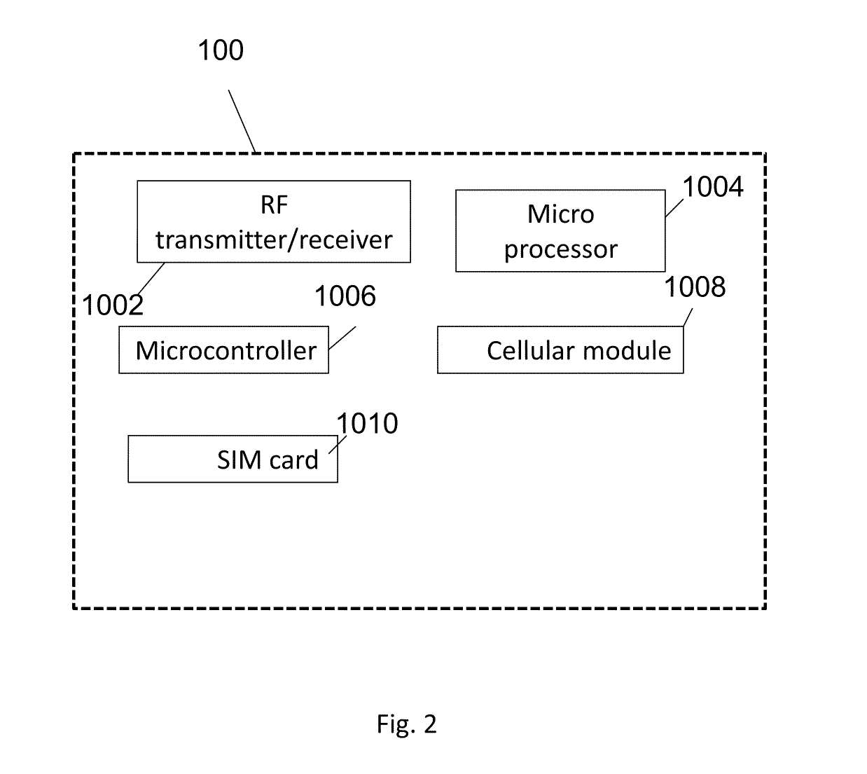

FIG. 2 is a block diagram illustrating a controller unit 100 design according to some embodiments of the invention. The controller unit 100 comprises a communication module 1002 such as an RF transmitter for communicating with the detection units, a microprocessor 1004 which is programmed to analyze the measurements of received acoustic sensors from the detection unit and from the shutoff unit and determine controls operation for each valve in the pipe construction according to an algorithm which is further described below (Optionally the controller further comprise a micro controller). According to some embodiments of the present invention it is suggested to add cellular network module 1008 (Such as GSM module) and a SIM card 1010 for enabling reporting alerts of identified leaks to predefined users phone numbers associated to technical support of the pipe construction. The controller unit 100 may also include a microcontroller 1006 for controlling the communication module 1002 for sending signals that will eventually operate the shutoff unit for closing the valve of the entrance point.

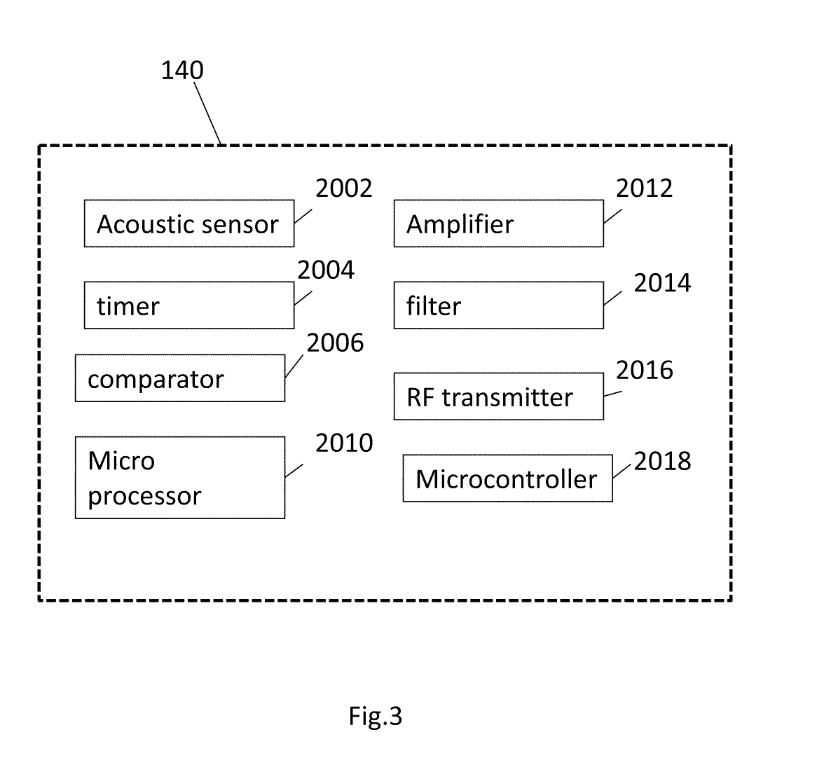

FIG. 3 is a block diagram of a detection unit 140, according to some embodiments of the invention. The detection unit 140 comprises an acoustic sensor 2002 which measures sounds signals near the detection unit 140 for identifying water flow at a controllable exit point, such as a tap, based on designated sound recognition algorithm. Such sound recognition algorithm programmed in the processing unit 2010, uses basic units including at least: a filtering unit 2014, amplifier unit 2012, timer unit 2004, comparator unit 2006 for identifying sound signals related to water flow including “dripping” sounds at predefined distance and filtering background noise. The analysis results may include only indication of detecting water flow beyond specific level. After analyzing the sounds signals, the microprocessor operates a communication module such as an RF transmitter 2016 to convey the water flow measurement at the respective exit point. According to some embodiments of the detection unit 140 can be implemented as a miniature electronic chip integrated as part of sticker (label) which can be easily attached on any object near the respective exit point. According to some embodiments of the present invention, each detection unit 140 has a unique identifier. Based on the measured flow data from identified detection units the controller device 100 can identify irregularities in water flow at specific exits points.

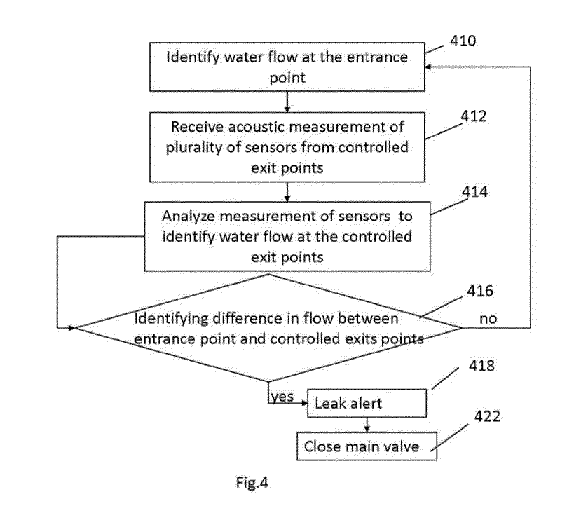

FIG. 4 is an illustration of the flow leak detection process according to some embodiments of the invention. The algorithm is activated by the controller, each time the measurement from the acoustic sensor at the entrance point indicates of water flow (step 410). Once a water flow is identified, the controller request and receives real-time measurements from acoustics sensors positioned in proximity to the controlled exit points (step 412). The measurements are analyzed to identify water flow and quantity of water flow in all exit points (step 414). At the next step, the measurements of the acoustic sensors at the entrance point are compared to the measurements of the acoustic sensors at exit points (step 416). In case of detecting the flow water at the entrance point is larger than sum of water flow from all exit points the algorithm may determine a leak alert state (step 418. In case of leak alert the controller determines if to send control signal to the shutoff unit for closing the valve at the mains entrance and/or to send an alert message to pre-defined designated phone numbers. According to some embodiments of the present invention the pipe construction may include plurality of entrance points connected to plurality of exits point. In such construction the algorithm is adapted to compare the sum of water flow measurements from all entrance points to sum of water flow measurements from all exit points to for determining leaks states.

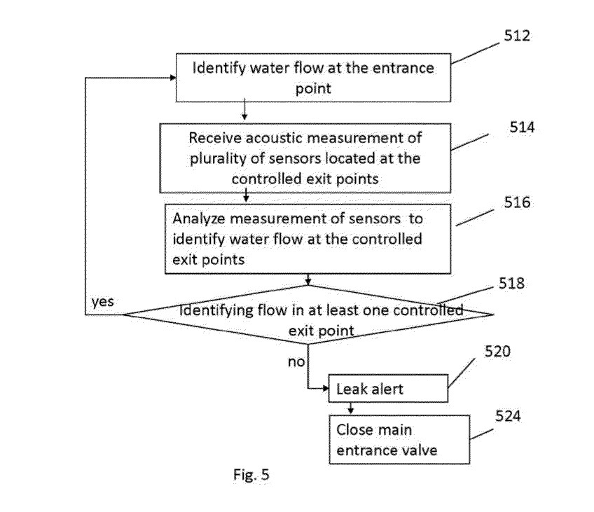

FIG. 5 is an illustration of the flow leak detection process according to some embodiments of the invention. This algorithm is equivalent to the algorithm described in FIG. 4, in which steps 514, 515 and 516 are the same as steps 410, 412 and 414, respectively, only assuming that all measured water flow from the entrance point is expected to be detected at the exit points. Under this assumption which is true for most private household pipe construction a leak is determined when a water flow is detected at the entrance point and no water flow is detected at the exit point (steps 518, 520 and 524).

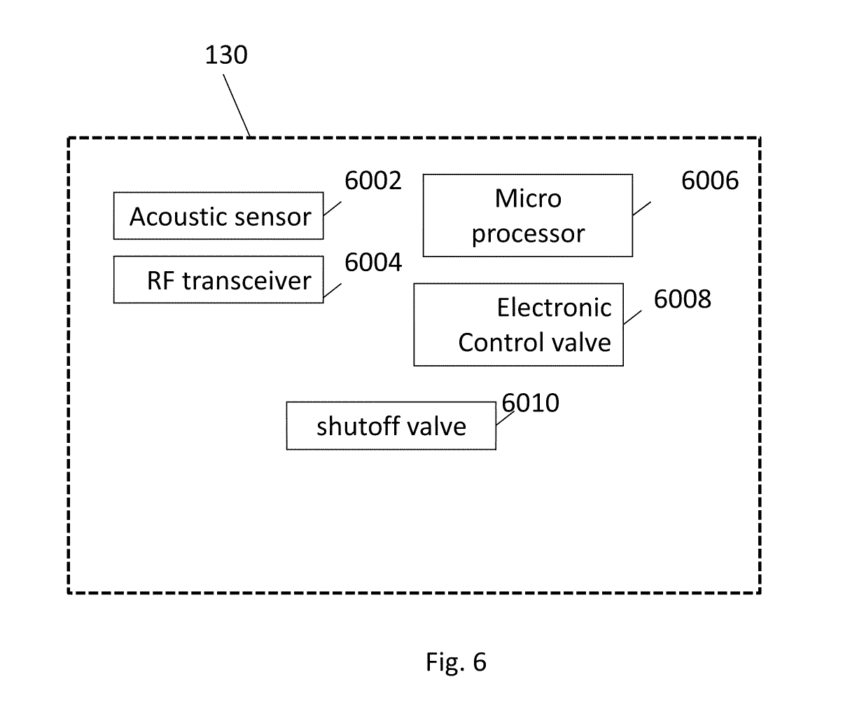

FIG. 6 is a block diagram the shutoff unit design according to some embodiments of the invention. The shutoff unit comprises an acoustic sensor 6002 which measures sounds signals for identifying water flow at the entrance point based on designated sound recognition algorithm. Such sound recognition algorithm is programmed in the processing unit 6006. After analyzing the sounds signals, the microprocessor operates a communication module such as a RF transmitter and receiver (i.e. transceiver) 6004 to convey measurement which indicate of water flow at the respective exit point. The electronic control valve 6008 is operated according to signal instruction coming from the controller through the transceiver 6004. The electronic control valve activates the shutoff valve 6010 according to given instruction.

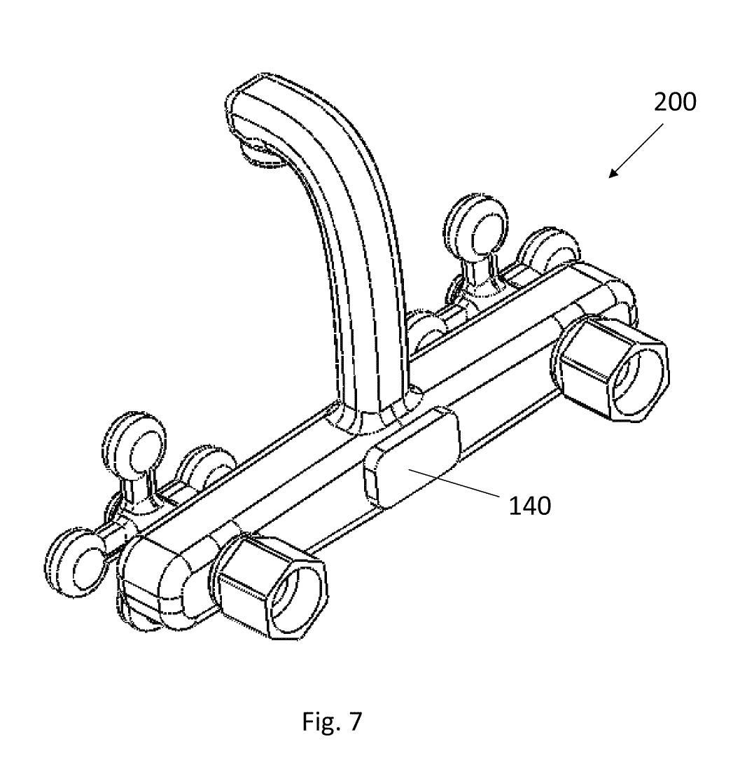

FIG. 7 is an illustration of a tap and associated detection unit according to some embodiments of the invention. The detection unit 200 is optionally attached at the rear side of a typical tap construction 140. Such position of the detection unit in proximity of the tap exit point enables to sense water flow coming out from the tap.

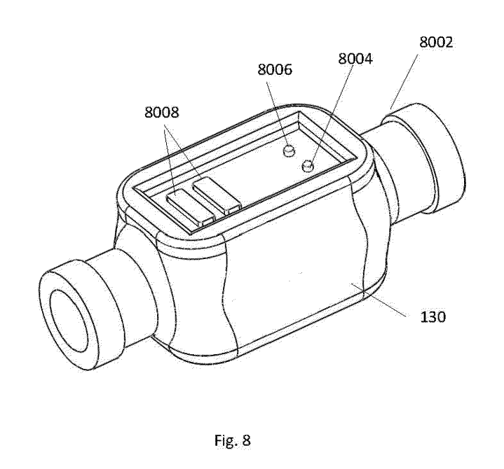

FIG. 8 is an illustration of a shutoff unit 130 according to some embodiments of the invention. The shutoff unit 130 includes connectors 8002 connectable to the entrance point of the pipe construction, alarm led 8004, normal mode led 8006 and displays 8008.

The acoustic sensors of the detection unit(s) and of the shutoff unit may be any known in the art acoustic sensor such as piezoelectric transducers that are configured to convert sound based signals of a specific spectral range suited for the specific liquid flow into electric signals. Other known in the art types of acoustic sensors can be used.

Example 1 describes a specific algorithm optionally used according to some embodiments of the invention to identify flow related defects such as piping leaks and experimental setup and results using thereof.

According to some embodiments of the invention, the identification of flow related defects is carried out using a designated flow analysis algorithm optionally operated by a designated software and/or hardware analysis module configured for measuring and analyzing spectral (frequency) behavior of the fluid flow in the pipe line in one or more locations thereof using the acoustic sensors and optionally one or more additional non-acoustic sensors. The algorithm uses reference spectral signatures of two or more piping/faucet states such as closed, open and semi-closed states taken from previous measurements of the same piping system or generally defined therein to identify the state of the fluid flow, preferably yet not necessarily in the frequency domain. For instance, the algorithm receives sensors data and calculates measured flow by subtracting the output flow measurement (calculated from the outlet sensor output) from the input flow (calculated from the inlet sensor output). This measured flow value is then compared to three optional state values closed, open or semi-closed e.g. by calculating absolute value of the subtraction of the measured value from each of the references values and determining to which state it is closest. In case it is closest to the state of “open” the algorithm may be designed to calculate the difference between the measured and reference value and determine a leakage situation if that difference exceeds a predefined threshold. If the difference is exaggerated i.e. exceeding another higher threshold an algorithm error may be determined.

For instance, the analysis module is located at a central unit including one or more processors and receives sensors output data via wireless communication such as via WiFi or Bluetooth RF communication link and calculates a sum (optionally integral) of the output flow of the pipeline and a sum (optionally integral) of the input flow for each specific timeframe. For each specific timeframe then the algorithm reduces the output flow sum from the input flow sum to identify the flow state of the system or part thereof.

There may be additional possible predefined flow states determining the number of open faucets of the pipe construction and their open state such as half open fully open etc. This will require the module to be adaptive and the system to include a learning module configured for identifying the various conditions of the specific pipe construction. This may require the user to open one or more faucets by reading instructions from a user interface provided by the system for allowing the system to learn the specific pipe construction and optionally also the environmental noise. Upon identification of a flow defect the system may be set to send an alert message to one or more authorized persons through their end devices such as mobile phones, tablet devices, PCs and the like via another communication link and additionally or alternatively set on an alarm.

Optionally, the system enables indicating the identified state of the pipe line (open/closed or semi-closed) to end users through a special display options of the user interface or through messaging services.

The algorithm may also be configured to determine the severity of the flow leak or other defect depending on the differences between the measured flow rate and the closest reference and indicating the severity level or the raw data to the end users upon sending of the relevant alert message.

In some embodiments, the modules are configured for identifying flow by analyzing the spectrum of the sensors data in the ultrasonic spectral range of the acoustic sensors' output, since this range is far less noise-sensitive.

According to some embodiments, the system performs a preliminary process for selecting the typical one or more frequencies for the pipe construction in the ultrasonic range for measuring value thereof for the comparison with reference values of corresponding frequencies in a non-defect state. In these embodiments, the open, close and semi-closed states for instance may be checked for more than one frequency for increasing defect identification accuracy.

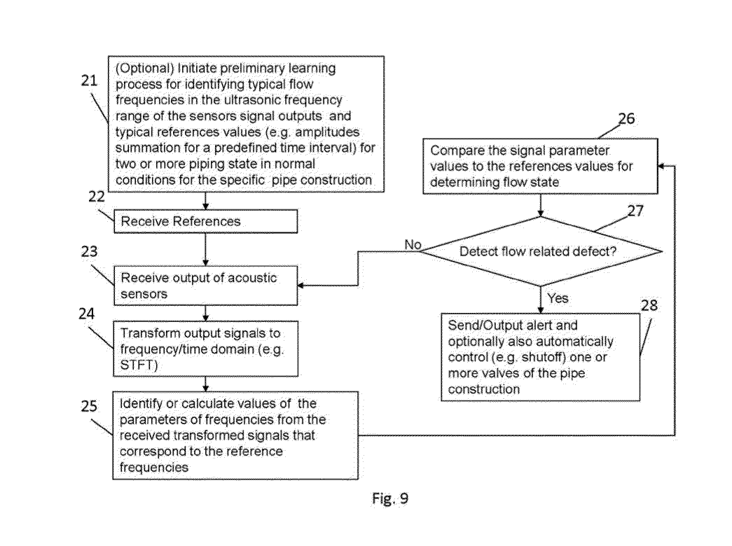

Reference is now made to FIG. 9 showing a flowchart of a process for identifying defects in a fluid pipe construction, according to some embodiments of the invention. The identification process may be preceded by an optional preliminary learning process 21 in which the typical frequencies of the specific pipe construction are identified in the ultrasonic spectral range and one or more parameters values of each selected frequency to form a reference to each of two or more piping states such as closed open and semi-closed. Once the references values are determined, the system can be operated for real time acoustic measuring and flow related defect identification. The identification process includes receiving the values for the one or more references of the piping states 22 and receiving in real time the outputs from the acoustics and if existing, the non-acoustic sensors 23. The received sensors output data is then processed e.g. by first transforming it to the time domain e.g. by using short time Fourier transform (STFT) 24 and then calculating parameter values for corresponding signal frequencies in the ultrasonic range 25. The calculated parameters are then compared to their corresponding references 267 to identify flow defects. The flow defect identification may be carried out by checking whether parameter values exceed their corresponding references in one of the references states e.g. by first calculating absolute value of the reduction of the reference from the calculated parameter value of the measured signal and checking which of the references of the states is the closest to see which state (open, closed or semi-closed) the measurement is most likely reflect. Once determining the piping state, the subtraction residue (difference between the reference and the measured value) is checked against at least one predefined threshold for defect identification 27. Once a flow defect is identified a defect notification and handling process may be automatically initiated including for instance sending alert messages 28 to predefined destinations such as to end devices of one or more authorized users, operating an alarm, and/or automatically shutting of the one or more valves of the pipe construction using one or more system devices enabling automatic shutoff and receiving shutoff commands optionally through wireless communication links.

The acoustic sensors of the detection unit(s) and of the shutoff unit may be any known in the art acoustic sensor such as piezoelectric transducers that are configured to convert sound based signals of a specific frequency range suited for the specific liquid flow into electric signals. Other known in the art types of acoustic sensors can be used.

### Example 1

### Water Flow Detection in Valves and Taps Using Binary Hypothesis Decision for Leakage Monitoring

### 1 Feasibility Study Using Professional Audio Equipment

### 1.1 Establish Measuring System

A measurement system was established using the high quality acoustic measurement equipment
1. a tap,
2. Brüel & Kjær 4942—½-inch diffuse-field microphone, 6 Hz to 16 kHz, prepolarized,
3. Brüel & Kjær NEXUS 2690 Conditioning Amplifier,
4. U24XL ESI audio—24-bit USB Audio Interface, and
5. Laptop with MATLAB.

### 1.2 Perform Initial Measurements

Measurements were taken for different positioning of the microphone with respect to the tap:
1. right on the tap,
2. at a distance of 0.3 m away from the tap and adjacent to the wall behind the tap, and
3. at a distance of 1.5 m away from the tap and adjacent to a wall in the room.

The microphone acoustic sensor was either coupled over the tap, located 0.3 meters away from the tap, and is located 1.5 meters away from the tap in the following experiments

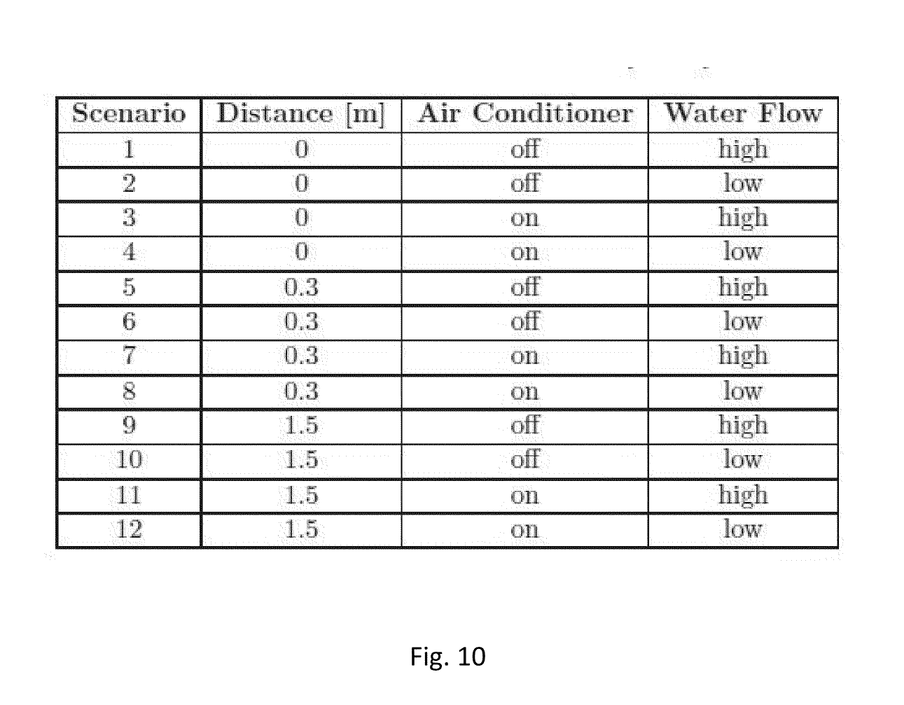

FIG. 10 shows a table showing all scenarios tested in the feasibility study. Every scenario was given a measurement. Recordings of the microphone signals were made wherein a background noise was introduced in some of the scenarios by using an air conditioner. The water tap was either closed, open with law flow, or open with high flow. Measurements were taken in a sampling rate of 48 KHz. For each scenario, 10 sessions of 5 seconds with 3 seconds delay were recorded.

1.3 Discriminate Typical Signals when Tap is Open or Closed

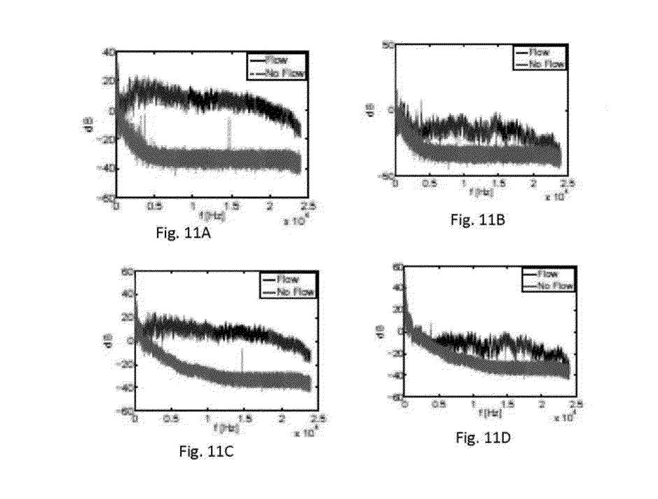

In this section a first discrimination is made for the different scenarios in the frequency domain between flow or no-flow conditions. Such initial discrimination was made for all scenarios tabulated in FIG. 10. It may be seen from FIGS. 11A-11D, 12A-12D and 13A-13D that discrimination is more detectable when:
1. The distance between the tab and the microphone decreased,
2. water flow is higher, and
3. air conditioner is off.

FIGS. 11A-11D show estimated spectrums of flow vs. no-flow when the microphones is coupled over the tap: FIG. 11A shows a spectrum for high-flow with air conditioning off; FIG. 11B shows a spectrum for low flow with air conditioning off; FIG. 11C shows a spectrum for high flow with air conditioning on; and FIG. 11D shows a spectrum for low flow with air conditioning on.

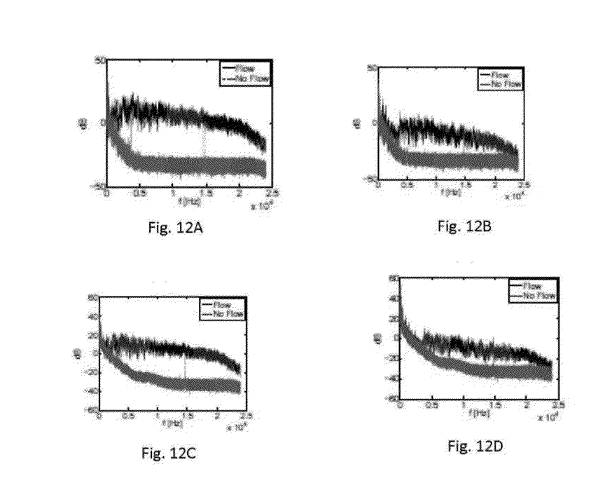

FIGS. 12A-12D show estimated spectrums of flow vs. no-flow when the microphone is located 0.3 meters from the: FIG. 12A shows a spectrum for High flow with air conditioning off; FIG. 12B shows a spectrum for low flow with air conditioning off; FIG. 12C shows a spectrum for high flow with air conditioning on; and FIG. 12D shows a spectrum for low flow with air conditioning on.

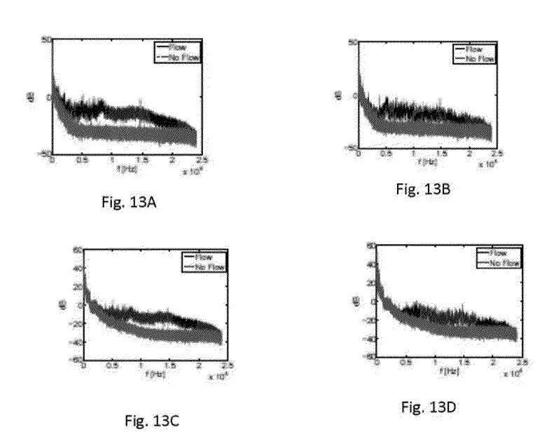

FIGS. 13A-13D show estimated spectrums of flow vs. no-flow when the microphone is located 1.5 meters from the: FIG. 13A shows a spectrum for high flow with air conditioning off; FIG. 13B shows a spectrum for low flow with air conditioning off; FIG. 13C shows a spectrum for high flow with air conditioning on; and FIG. 13D shows a spectrum for low flow with air conditioning on.

### 1.4 Feature Vectors

### 1.4.1 Feature Extraction

Feature extraction was made to the recorded signal from each scenario. Feature extraction in this project consist of the following steps:
1. Apply time windowing,
2. Apply filter bank,
3. Calculate energy in each filter bank in dB.

As a first step, time domain windowing is performed using Hamming windows of the form:

$$w [ n ] = 0.54 - 0.46 cos ( \frac{2 π n}{N - 1} ) \qquad ( 1 )$$

The purpose of avoiding rectangular windows is to prevent distortions in the frequency domain exhibited by convolution with a sinc function. Windows duration is 1 s, which corresponds to Nwindow=48000 samples in 48 KHz. Overlapping of 0.5 s is used. Hence for the i'th time domain section we have

sᵢ[n]=s[i·Nₛₜₑₚ+n]·w[n], n=0, . . . ,N_{window}−1 (2)

where Nₛₜₑₚ=N_{window}−Nₒᵥₑᵣₗₐₚ.

Once overlapping 1 s sections were multiplied using the Hamming window, a frequency domain analysis is performed on each section. This is performed using filter bank. Essentially, in this project 0.5 KHz band-pass filters were employed such that they are linearly and equally spread from 0 to 24 KHz (half Nyquist frequency), with no overlapping. The band-pass filters were simply implemented by selecting the corresponding frequency coordinate in the FFT of the window section.

Sᵢⱼ[k]=FFT{sᵢ}[j·NBW+k], k=0, . . . ,N_{BW}−1 (3)

where N_{BW} is the number of FFT points in a BW of one band-pass in the filter-bank which equals to

$${N}_{BW} = \frac{BW}{{F}_{s}} \times {N}_{window} \qquad ( 4 )$$

The last step in the feature extraction process is to calculate the energy in dB units from each filter bank, and store it as the value of the j'th coordinate in the i'th feature vector, where “i” is the index of the time-domain window section, and j is the index of the band-pass filter in the filter bank. i is the index of the time-domain window section, and j is the index of the band-pass filter in the filter bank.

$${x}_{ij} = 10 {log}_{10} {\sum }_{k = 0}^{{N}_{BW} - 1} {\vert {S}_{ij} [ k ] \vert}^{2} \qquad ( 5 )$$

In that essence, there are M feature vectors xᵢ where i=0 . . . M−1, of which dimension is such that xᵢ=[x_{i 0}, . . . , x_{i (N-1)}]

### 1.4.2 Feature Selection

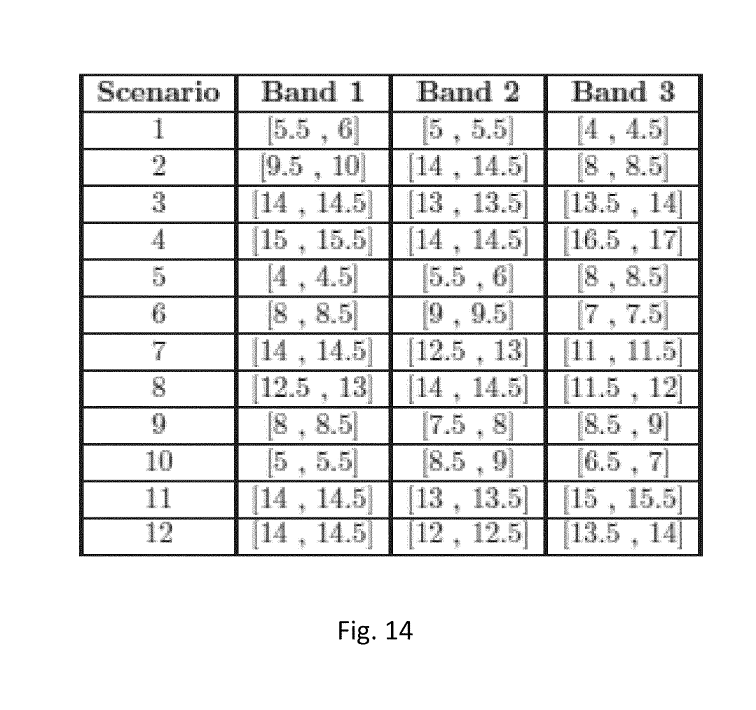

Feature selection at this stage was performed by selecting the coordinates with highest variance in the database. The table in FIG. 14 shows for each scenario from the table in FIG. 10, the three highest features variance coordinates in terms of band-pass frequencies.

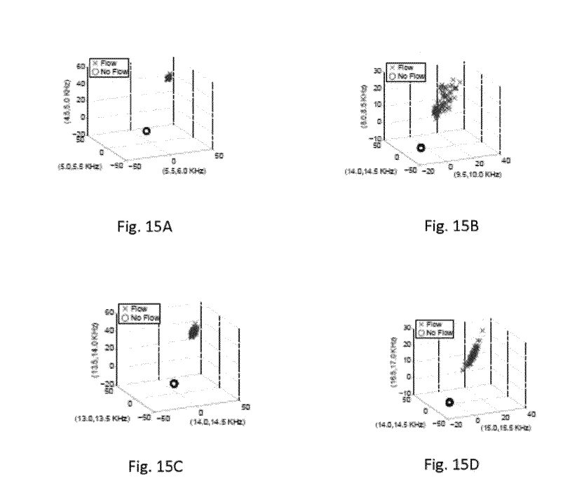

FIGS. 15A-15D, 16A-16D, 17A-17D show a 3D scatter plot of the three coordinates with largest variance selected for each scenario:

FIGS. 15A-15D show a 3D scatter plot of selected features of flow vs. no-flow when the microphone is coupled over the tap: FIG. 15A shows a scattered plot of high flow with air conditioning off; FIG. 15B shows a scattered plot of low flow with air conditioning off; FIG. 15C shows a scattered plot of high flow with air conditioning on; and FIG. 15D shows a scattered plot of low flow with air conditioning on.

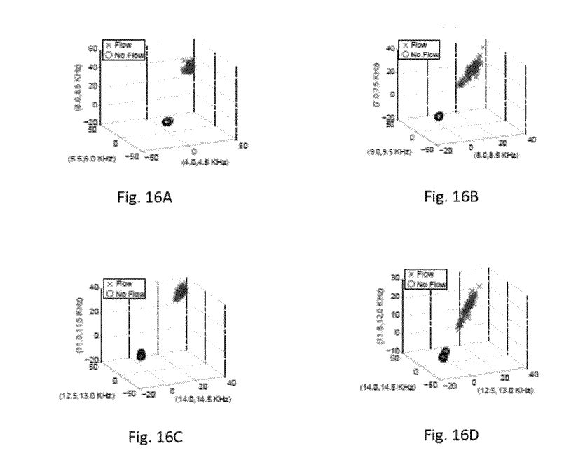

FIGS. 16A-16D show a 3D scatter plot of selected features of flow vs. no-flow when the microphone is located 0.3 meters from the tap: FIG. 16A shows a scattered plot of high flow with air conditioning off; FIG. 16B shows a scattered plot of low flow with air conditioning off; FIG. 16C shows a scattered plot of high flow with air conditioning on; and FIG. 16D shows a scattered plot of low flow with air conditioning on.

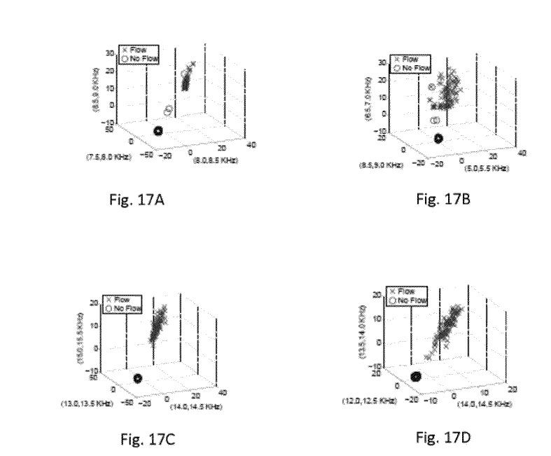

FIGS. 17A-17D show a 3D scatter plot of selected features of flow vs. no-flow when the microphone is located 1.5 meters from the tap: FIG. 17A shows a scattered plot of high flow with air conditioning off; FIG. 17B shows a scattered plot of low flow with air conditioning off; FIG. 17C shows a scattered plot of high flow with air conditioning on; and FIG. 17D shows a scattered plot of low flow with air conditioning on.

### 1.5 Model Distribution

1.5.1 Model Feature Vector Distribution From FIGS. 15A-17D, it is reasonable to assume a Gaussian distribution of the feature vectors. Hence using Gaussian mixture model (GMM) is not required, a fact that will facilitate implementation on processor/controller. The class-conditional probability-density function (PDF) distribution of the feature vectors is therefore assumed as:

$$p ( x \vert ω ) = \frac{1}{{( 2 π )}^{\frac{d}{2}} {\vert {\sum }_{ω} \vert}^{\frac{1}{2}}} {e}^{- \frac{1}{2} {( x - {μ}_{ω} )}^{T} {\sum }_{ω}^{- 1} ( x - {μ}_{ω} )} \qquad ( 6 )$$

where x is the feature vector, ω is the class which can be either “flow” or “no-flow”, μ_{ω} is the mean vector corresponding to that class, and Σ_{ω} is the covariance matrix corresponding to that class.

Since μ_{ω} and Σ_{ω} are not known, they are estimated as the sample-mean vector and sample covariance matrix, respectively, to have:

$$\hat{p} ( x \vert ω ) = \frac{1}{{( 2 π )}^{\frac{d}{2}} {\vert {\hat{\sum }}_{ω} \vert}^{\frac{1}{2}}} {e}^{- \frac{1}{2} {( x - {\hat{μ}}_{ω} )}^{T} \hat{{\sum }_{ω}^{- 1}} ( x - {\hat{μ}}_{ω} )} \qquad ( 7 )$$

### 1.5.2 Display Distribution Using PCA

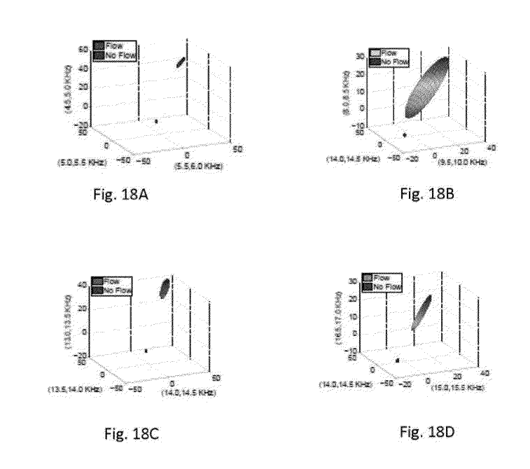

FIGS. 18A-18D, 19A-19D and 20A-20D show a 3D Gaussian equi-probability plot of the three coordinates with largest variance selected for each scenario. The equi-probability ellipsoid of conditional Gaussian distribution are displayed using principle component analysis (PCA) procedure. The eigenvalues of the sampled covariance matrix which correspond to of the three largest variance coordinates are selected. Then, eigenvectors which correspond to these eigenvalues are used as the axes of the ellipsoids.

FIGS. 18A-18D show Gaussian equi-probability plots for a system in which the microphone is coupled over the tap, wherein FIG. 18A shows a plot for high flow with air conditioning off; FIG. 18B shows a plot for low flow with air conditioning off; FIG. 18C shows a plot for high flow with air conditioning on; and FIG. 18D shows a plot for low flow with air conditioning on.

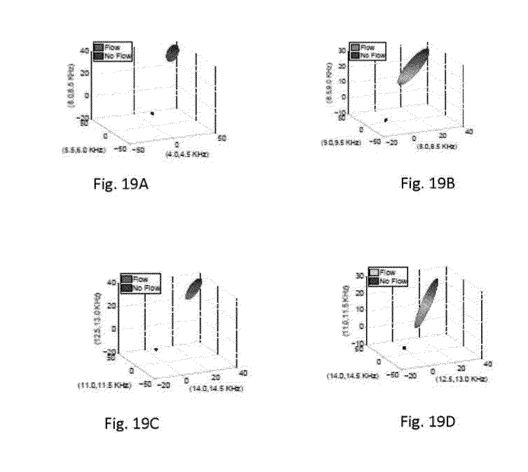

FIGS. 19A-19D show Gaussian equi-probability plots for a system in which the microphone is located 0.3 meters from the tap, wherein FIG. 19A shows a plot for high flow with air conditioning off; FIG. 19B shows a plot for low flow with air conditioning off; FIG. 19C shows a plot for high flow with air conditioning on; and FIG. 19D shows a plot for low flow with air conditioning on.

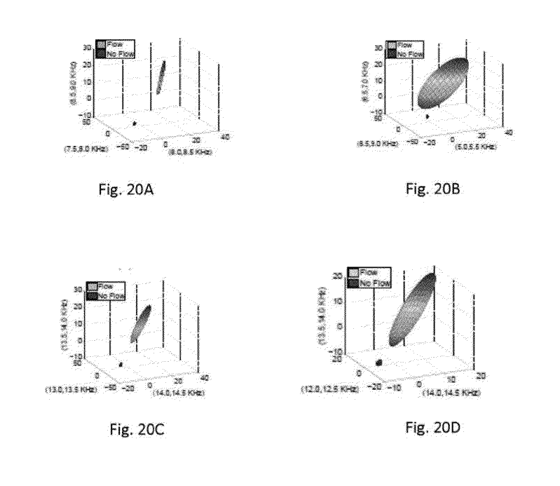

FIGS. 20A-20D show Gaussian equi-probability plots for a system in which the microphone is located 1.5 meters from the tap, wherein FIG. 20A shows a plot for high flow with air conditioning off; FIG. 20B shows a plot for low flow with air conditioning oft FIG. 20C shows a plot for high flow with air conditioning on; and FIG. 20D shows a plot for low flow with air conditioning on.

### 1.6 Likelihood Ratio Test

### 1.6.1 Design Likelihood Ratio Test

According to the Bayes hypothesis decision criterion, given a feature vector x, a “flow” or “no-flow” will be decided according to the a-posteriori probability function

P(ω₁|x) [symbol] _{ω}_{₀}^{ω}^{₁}P(ω₀|x) (8)

where ω₁ represents the “flow” model, ω₀ represents the “no-flow” model. Using Bayes rule (8) becomes

$$\frac{p ( x \vert {ω}_{1} ) P ( {ω}_{1} )}{p ( x )} {≷}_{{ω}_{0}}^{{ω}_{1}} \frac{p ( x \vert {ω}_{0} ) P ( {ω}_{0} )}{p ( x )} \\ p ( x \vert {ω}_{1} ) P ( {ω}_{1} ) {≷}_{{ω}_{0}}^{{ω}_{1}} p ( x \vert {ω}_{0} ) P ( {ω}_{0} ) \qquad ( 9 )$$

In case where the a-priory probability functions P(ω₁) and P(ω₂) are not known, we assume 50% for both, and the Bayes decision rule becomes a likelihood ratio test (LRT) according which:

$$\frac{p ( x \vert {ω}_{1} )}{p ( x \vert {ω}_{0} )} {≷}_{{ω}_{0}}^{{ω}_{1}} 1 \qquad ( 10 )$$

Equation (10) can be given in a log form using:

log p(x|ω₁)−log p(x|ω₀) [symbol] _{ω}_{₀}^{ω}^{₁}0 (11)

where the functions log p (x|ω₁) are also known as the log-likelihood of a feature vector x to be from class ωᵢ.

### 1.6.2 Detection Error Trade-Off

In order to increase robustness to unknown values of the a-priory probability functions, a score function is applied which indicates the difference of the log-likelihood functions, and compared to a threshold γ (gamma) instead of zero, for miss detection vs. false alarm error trade-off. Substituting a Gaussian conditional density function of (6) results in a score function which is the difference between the Mahalanobis distance of x from the two classes. This can be written in the following form:

Λ(x) [symbol] _{ω}_{₀}^{ω}^{₁}γ (12)

where Λ(x) is the score function which is identical to the difference in the Mahalanobis distances:

Λ(x)=(x−μ₀)^{T}Σ₀⁻¹(x−μ₀)−(x−μ₁)^{T}Σ₁⁻¹(x−μ₁) (13)

### 1.6.3 Evaluate Threshold for Desired Miss-Detection Probability.

The probability of miss detection and false alarm are set by the threshold γ and are equal to:

P_{MISS}(γ)=P(Λ(x)≦γ|ω₁) (14)

P_{FA}(γ)=P(Λ(x)>γ|ω₀) (15)

Since the outcome of a plant that is flooded is more severe than just turning of the water supply for the night, an emphasis will be made on the miss-detection probability. Hence in every experiment γP will be set by:

$${γ}_{P} = arg {max}_{γ} \{ γ ∈ \vert {P}_{MISS} ( γ ) \geq P \} \qquad ( 16 )$$

### 1.6.4 Design Experiment

The extracted features of all recorded data was equally split into three feature vector databases, namely:
1. training database,
2. development database, and,
3. validation database

This division was made for each scenario, i.e. location of microphone, air-conditioner situation, and high or low water flow. Training database is used to calculate the sample mean and covariance matrix from. Development database is used in the feature selection process, in which feature coordinates of maximum variance are selected. Validation database is used to test new feature vectors that are neither found in the training nor in the development databases, in order to increase the generality of the validation process.

Miss detection probability given a scenario was then calculated as the number of cases in which “flow” was detected as “no-flow”, divided by the number of feature vectors in the validation database of the same scenario. In a similar manner, false alarm probability given a scenario was calculated as the number of cases in which “no-flow” was detected as “flow”, divided by the number of feature vectors in the validation database of the same scenario.

It seems that if the same scenario is used for training, development and validation, perfect performance can be achieved. Cross-scenario validation is a subject for future research.

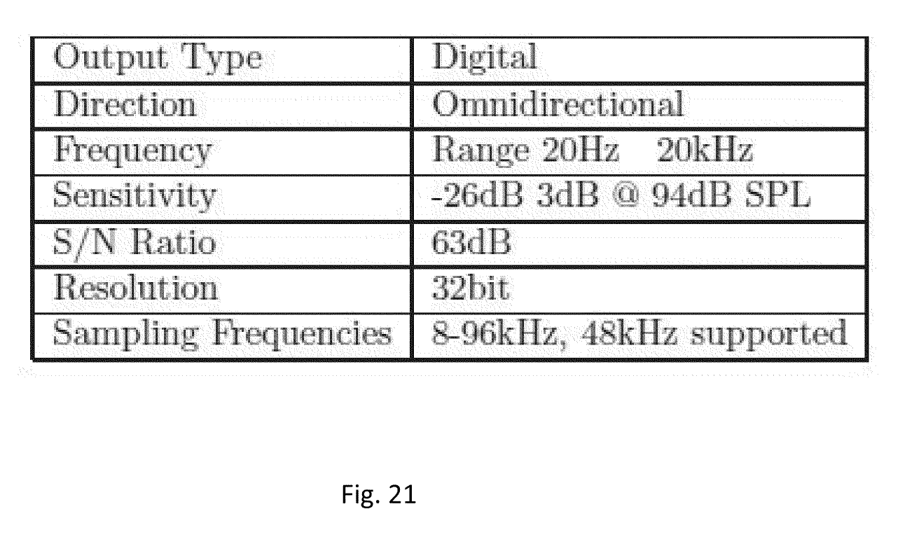

The table in FIG. 21 shows all scenarios tested in the feasibility study. Every scenario was measured. Recordings of the signals were made when the air conditioner was either on or off. The water tap was either closed, open with law flow, or open with high flow.

2.3 Discriminate Signals with MEMS Microphone

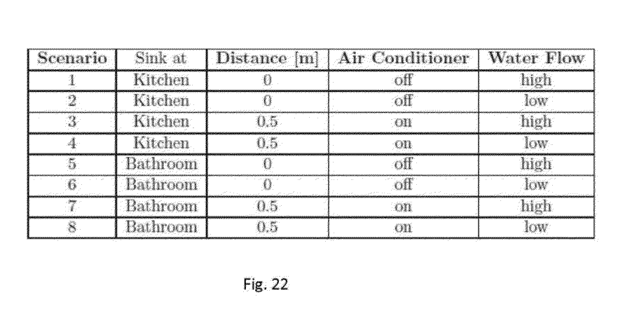

In this section discrimination is made for the different scenarios at home when the MEMS microphone is used. Such initial discrimination was made for all scenarios tabulated in the table in FIG. 21. FIG. 22 shows a table indicating all the different scenarios tested wherein the tap is in different high or low condition and the air condition is on or off.

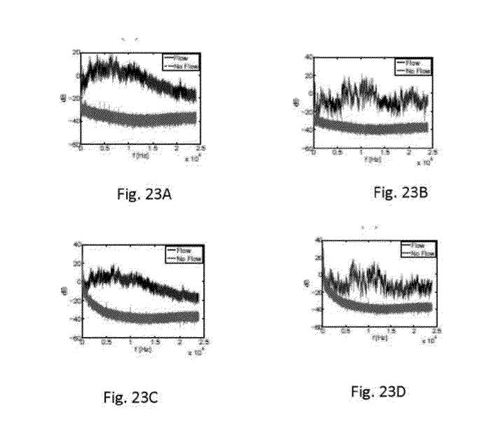

FIGS. 23A-23D show flow vs. no-flow spectrums of acoustic signals recorded by using a microphone located over a kitchen tap: FIG. 23A shows the spectrum in high flow with air conditioning off scenario; FIG. 23B shows the spectrum in low flow with air conditioning off scenario; FIG. 23C shows the spectrum in high flow with air conditioning on scenario; and FIG. 23D shows the spectrum in low flow with air conditioning on scenario.

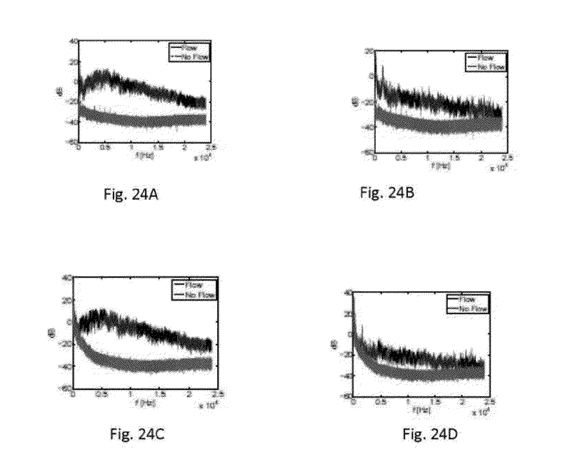

FIGS. 24A-24D show flow vs. no-flow spectrums of acoustic signals recorded by using a microphone located 0.5 meters from the kitchen tap: FIG. 24A shows the spectrum in high flow with air conditioning off scenario; FIG. 24B shows the spectrum in low flow with air conditioning off scenario; FIG. 23C shows the spectrum in high flow with air conditioning on scenario; and FIG. 23D shows the spectrum in low flow with air conditioning on scenario.

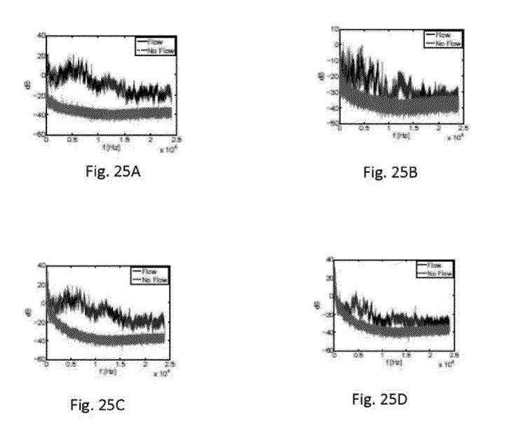

FIGS. 25A-25D show flow vs. no-flow spectrums of acoustic signals recorded by using a microphone located over a shower tap: FIG. 25A shows the spectrum in high flow with air conditioning off scenario; FIG. 25B shows the spectrum in low flow with air conditioning off scenario; FIG. 25C shows the spectrum in high flow with air conditioning on scenario; and FIG. 25D shows the spectrum in low flow with air conditioning on scenario.

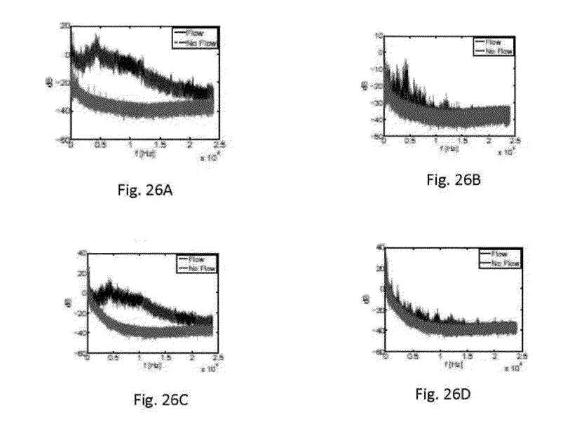

FIGS. 26A-26D show flow vs. no-flow spectrums of acoustic signals recorded by using a microphone located 0.5 meters from the shower tap: FIG. 26A shows the spectrum in high flow with air conditioning off scenario; FIG. 26B shows the spectrum in low flow with air conditioning off scenario; FIG. 26C shows the spectrum in high flow with air conditioning on scenario; and FIG. 26D shows the spectrum in low flow with air conditioning on scenario.

2.4 Feature Extraction and Feature Selection with Train-Develop-Test Cross-Databases

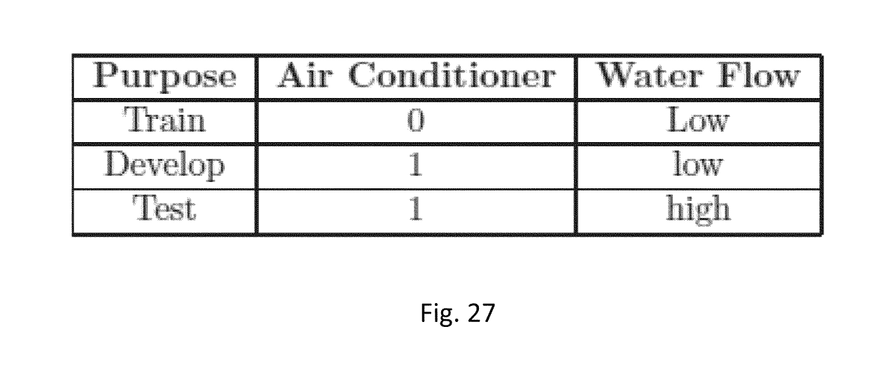

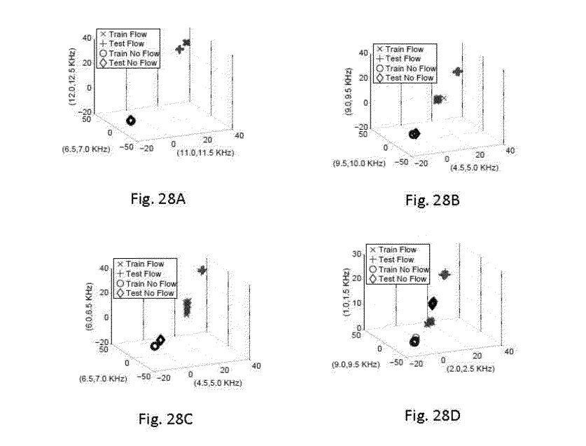

In this section training is performed with low water flow without air conditioning or any other noise. Feature selection is performed with low water flow with air conditioning, and testing is performed using high water flow and with air conditioning. The table in FIG. 27 summarizes these conditions. This is performed in the kitchen and bathroom, when the microphone is coupled to the tap or farther therefrom. FIGS. 28A-28D show the scatter plot of cross-database feature extraction, as detailed in the table of FIG. 27, in the Kitchen and Bathroom sinks, when the microphone is located either on the tap, or 0.5 m away from the tap. FIGS. 28A-28C may promise good detection However FIG. 28D shows a potential problem in detection. A conclusion that may seemingly be drawn here is that if different scenarios are used for training and testing, the microphone may have to be over the tap. This conclusion will be reconsidered in the following section.

2.5 Detection with Train-Develop-Test Cross-Databases

In this section water flow detection is performed with the conditions specified in the table of FIG. 27, in the kitchen and in the bathroom, whether the microphone is on the tap or not.

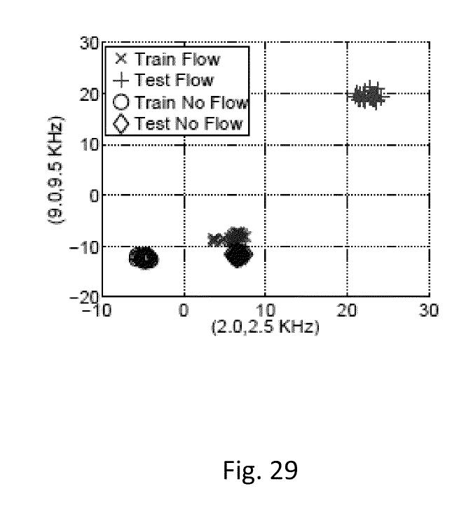

All figures show perfect detection, i.e., show that there is a threshold that yields zero miss and false alarm errors. This may be surprising due to the fact that FIG. 28(d) showed potential problem in detection, in the bathroom where the microphone is located 0.5 m away from the tap. Hence FIG. 28D was reproduced in 2D, with the two maximal variance features, to the form displayed in FIG. 29.

From FIG. 29 it may clearly be seen that the “no flow” test vectors are nearer to the “flow” train vectors than the “no flow” train vectors. This might result in high false alarm error. However, since in this example the “flow” test vectors are so far away, a threshold for the score function can be set such that zero false alarm is achieved, under the restriction of zero miss. In real application scenario, this however might still be problematic or non-robust.

### 3 Algorithm in Summary

The algorithm has two main modes, namely, “learning” and “normal run” modes.

### 3.1 Databases

The “training”, “development” and “testing” databases are used in the learning mode. Each database should contain “flow” and “no-flow” signals for the flow hypothesis and for the no flow hypothesis. Measurements in the database should be taken in a sampling rate of 48 KHz. It is recommended to use at least 10 sessions of 5 seconds with 3 seconds delay between the sessions, for each hypothesis. It is recommended to use different conditions (i.e. air conditioner or other noise) in the training and development databases to increase robustness. It is recommended to use lower flow in the training database than in the testing database. In general, it is recommended to use lower flow in the training database than in the normal run mode.

### 3.2 Learning Mode

Learning is performed according to the following steps:
1. Apply feature extraction as described in Sec. 1.4.1 to a “Development” database which contains “flow” and “no-flow” signals. Use Hamming windows of the form:

$$w [ n ] = 0.54 - 0.46 cos ( \frac{2 π n}{N - 1} ) \qquad ( 17 )$$

Windows duration is 1 s, which corresponds to N_{window}=48000 samples in 48 KHz. Use overlapping of 0.5 s in windows. For the i'th time domain section applies:

sᵢ[n]=s[i·Nₛₜₑₚ+n]·w[n], n=0, . . . , N_{window}−1 (18)
Apply 0.5 KHz band-pass filters which are linearly and equally spread from 0 to 24 KHz (half N_{yquist} frequency), with no overlapping. This is performed by selecting the corresponding frequency coordinate in the FFT of the windowed section.

Sᵢⱼ[k]=FFT{sᵢ}[j·N_{BW}+k], k=0 . . . , N_{BW}−1 (19)
Where NBW is the number of FFT points in a BW of one band-pass in the filter-bank which equals to

$${N}_{BW} = \frac{BW}{{F}_{s}} \times {N}_{window} \qquad ( 20 )$$

The last step in the feature extraction process is to calculate the energy in dB units from each filter bank, and store it as the value of the j'th coordinate in the i'th feature vector, where i is the index of the time-domain window section, and j is the index of the band-pass filter in the filter bank.

$${x}_{ij} = 10 {log}_{10} {\sum }_{k = 0}^{{N}_{BW} - 1} {\vert {S}_{ij} [ k ] \vert}^{2} \qquad ( 21 )$$

In that essence, there are M feature vectors xi where i=0 . . . M−1, of which dimension is N such that xi=xi 0, . . . , xi(N−1)]. Each coordinate in the feature vector is associated with a frequency band.
2. Select the coordinates in the feature vectors with the maximal variance, along all the database, including the “flow” and “no-flow” feature vectors Thus, most important frequency bands are attributed. It is recommended to use between 5 and 10 coordinates in the final feature vector, after feature selection.
3. Apply feature extraction as in step 1 to a “Training” database, only for selected bands in step 2.
4. Apply training using the feature vectors which were extracted in step 3. This is performed by calculating the sample mean vectors

$${μ}_{i} = \frac{1}{{N}_{i}} {\sum }_{n = 1}^{{N}_{i}} {x}_{n}^{i} \qquad ( 22 )$$

Where i=0 means “no-flow”, and i=1 means “flow”. Also, calculate the sample covariance matrices

$${\sum }_{i} = \frac{1}{{N}_{i} - 1} {\sum }_{n = 1}^{{N}_{i}} ( {x}_{n}^{i} - {μ}_{i} ) {( {x}_{n}^{i} - {μ}_{i} )}^{T} \qquad ( 23 )$$

again, where i=0 means “no-flow”, and i=1 means “flow”. Save the sample mean vector and the inverse of the sample covariance matrix for “flow” and “no-flow” hypotheses.
5. Apply feature extraction as described in step 1 to a “Testing” database, only for selected bands in step 2.
6. Calculate scores of all feature vectors which were extracted in step 5 according to:

Λ(x)=(x−+μ₀)^{T}Σ₀⁻¹(x−μ₀)−(x−μ₁)^{T}Σ₁⁻¹(x−μ₁) (24)
Again, where i=0 means “no-flow”, and i=1 means “flow”.
7. Apply performance analysis and derive the optimal threshold: Start with lowest γ. Apply for each feature vector

Λ(x) [symbol] _{“no flow”}^{“flow”}γ (25)
Increase γ and repeat. Stop at the maximal γ for which a permitted number of “flow” feature vectors are detected as “no-flow” feature vectors.

### 3.3 Normal Run Mode

Normal run is performed according to the following steps:
1. Applying feature extraction (see step 1 in learning mode) to a running signal, only for selected bands (see step 2 in the learning mode).
2. Calculate the score of the feature vector (see step 6 in the learning mode).
3. Compare the score to the optimal threshold
4. Use a counter to count how many times a feature vector score is above the threshold successively. If above a certain amount of time, announce “flow”.

### CONCLUSION

A leakage monitoring research work was presented, using a binary hypothesis testing approach. Feature extraction was performed using time windowing and filter banks. The distribution of the feature vectors was assumed Gaussian with non-diagonal covariance matrix. Therefore modeling the distribution consist of the estimation of the mean vector and covariance matrix of these feature vectors, given either “flow” or “no-flow” hypothesis. A log-likelihood ratio test was performed for detection of water flow, and performance was measured using DET curves, showing the compromise between miss and false alarm probabilities.

As a first step, a feasibility study was performed using professional room-acoustics measurement equipment, with same conditions for training and testing. In the second step, middle-rated audio equipment was used and different scenarios were used in training and testing. Zero miss and false alarm probabilities has shown to be feasible in a correct tuning of score threshold. However, the scatter plot of the feature vectors may prove non-robustness of the system in case that the microphone is far from the tap and different scenarios are used in training and testing.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method for identifying defects in a fluid pipe construction, said method comprising for each timeframe:
a. receiving output signal data of at least two acoustic sensors configured for measuring flow related acoustic measures of said pipe constructions at least at the entrance point and at least one exit points thereof; and
b. processing said received output signal data for identifying one or more types of flow related defects, using ultrasonic spectral range of the received signal data, wherein said identification is carried out by calculating at least the difference between the flow in the entrance and exit points of the pipe construction within the ultrasonic spectral range and comparing the calculated difference with at least two references indicating at least two flow states, said references are indicative of the flow states within the ultrasonic spectral range under normal conditions.

2. The method according to claim 1, wherein said processing of the received signal data further comprises transforming the signal or at least ultrasonic range part thereof to the time domain.

3. The method according to claim 2, wherein said processing further comprises selecting at least one frequency within the ultrasonic range as the representative indication of the flow and comparing value of its amplitude or a parameter related thereto with states references values associated with the same corresponding at least one frequency.

4. The method according to claim 1, further comprising outputting an alert message upon identification of a flow defect.

5. The method according to claim 4, wherein said alert message is outputted by sending thereof to at least one end device of at least one authorized user over at least one communication link.

6. The method according to claim 1, wherein said signal data is received from said acoustic sensors through wireless communication.

7. The method according to claim 1, wherein said at least two references comprise three references indicating three different flow states of: closed, in which no faucet of the pipe construction is open and therefore not exiting flow is sensed, fully open, in which at least one of the pipe construction faucets is fully open enabling full flow of the fluid through the piping thereof, and semi-closed, in which some of the faucets are open or one is semi-open.

8. The method according to claim 1, wherein the determination of a flow defect comprises determination of leakage in the pipeline of the pipe construction, and wherein said leakage is identified once the calculated difference between the input and output flows exceeds a predefined threshold.

9. The method according to claim 1 further comprising operating a preliminary learning process for determining the at least two references of the specific pipe construction.

10. A system for identifying defects in a fluid pipe construction, said system comprising:
(i) a plurality of acoustic sensors located in proximity to a pipeline of the pipe construction foe measuring flow in different locations of the pipeline including at least at the entrance point and at least one exit point thereof; and
(ii) at least one processing unit configured for receiving output signal data of said acoustic sensors and processing said received output signal data for identifying one or more types of flow related defects, using ultrasonic spectral range of the received signal data, wherein said identification is carried out by calculating at least the difference between the flow in the entrance and exit points of the pipe construction within the ultrasonic spectral range and comparing the calculated flow difference with at least two references indicating at least two flow states, said references are indicative of the flow states within the ultrasonic spectral range under normal conditions.

11. The system according to claim 10 further comprising:
a) at least one detection unit positioned in proximity to at least one exit point of said pipe construction and comprises an acoustic sensor and a wireless communication unit; and
b) at least one electronically controlled shutoff unit installed in proximity to each entrance point of the pipe construction, said at least one shutoff unit comprising a controllable valve, an acoustic sensor and a wireless communication unit arranged for wirelessly communicating with said at least one detection unit via at least one first communication link, a controller network device for receiving identifying flow related defects and control said valve of each said shutoff unit according to the detected defect and a predefined control program associated with the identified defect,
wherein said processing unit is embedded in said shutoff unit.

12. The system according to claim 11, wherein said wireless communication unit is configured to receive and transmit data through at least one of the following wireless communication technologies: radio frequency (RF) based communication, optical communication.

13. The system according to claim 10 further comprising at least one non-acoustic sensor for flow measurement, wherein said processing is done also using output data of said at least one non-acoustic sensor.

14. The system according to claim 10, wherein said at least one shutoff unit is further configured to output and/or transmit alerts upon identification of a flow defect.

15. The system according to claim 10, wherein said processing further comprises selecting at least one frequency within the ultrasonic range as the representative indication of the flow and comparing value of its amplitude or a parameter related thereto with states references values associated with the same corresponding at least one frequency.
